(19) United States
(12) Patent Application Publication
(10) Pub. No.: US 2014/0092956 A1
(43) Pub. Date: Apr. 3, 2014

(54) ADAPTIVE TRANSFORM OPTIONS FOR SCALABLE EXTENSION

(71) Applicant: MOTOROLA MOBILITY LLC, Libertyville, IL (US)

(72) Inventors: Krit Panusopone, San Diego, CA (US); Limin Wang, San Diego, CA (US)

(73) Assignee: MOTOROLA MOBILITY LLC, Libertyville, IL (US)

(21) Appl. No.: 14/038,926

(22) Filed: Sep. 27, 2013

Related U.S. Application Data
(60) Provisional application No. 61/707,949, filed on Sep. 29, 2012.

(51) Int. Cl. H04N 7/50

(52) U.S. Cl. CPC H04N 19/00781
USPC 375/240.02

(57) ABSTRACT

In one embodiment, a method determines a first size of a first unit of video used for a prediction process in an enhancement layer. The enhancement layer is useable to enhance a base layer. The method then determines a second size of a second unit of video used for a transform process in the enhancement layer and determines whether adaptive transform is to be used in the transform process based on the first size of the first unit and the second size of the second unit where the adaptive transform provides at least three transform options. When adaptive transform is used, a transform option is selected from the at least three transform options for the transform process.

### CROSS REFERENCE TO RELATED APPLICATIONS

The present application claims priority to U.S. Provisional Patent Application 61/707,949, filed Sep. 29, 2012, the contents of which are incorporated herein by reference in their entirety.

### BACKGROUND

Video-compression systems employ block processing for most of the compression operations. A block is a group of neighboring pixels and may be treated as one coding unit in terms of the compression operations. Theoretically, a larger coding unit is preferred to take advantage of correlation among immediate neighboring pixels. Various video-compression standards, e.g., Motion Picture Expert Group (“MPEG”)-1, MPEG-2, and MPEG-4, use block sizes of 4×4, 8×8, and 16×16 (referred to as a macroblock).

High efficiency video coding (“HEVC”) is also a block-based hybrid spatial and temporal predictive coding scheme. HEVC partitions an input picture into square blocks referred to as coding tree units (“CTUs”) as shown in FIG. 1. Unlike prior coding standards, the CTU can be as large as 128×128 pixels. Each CTU can be partitioned into smaller square blocks called coding units (“CUs”). FIG. 2 shows an example of a CTU partition of CUs. A CTU 100 is first partitioned into four CUs 102. Each CU 102 may also be further split into four smaller CUs 102 that are a quarter of the size of the CU 102. This partitioning process can be repeated based on certain criteria, such as limits to the number of times a CU can be partitioned. As shown, CUs 102-1, 102-3, and 102-4 are a quarter of the size of CTU 100. Further, CU 102-2 has been split into four CUs 102-5, 102-6, 102-7, and 102-8.

Each CU 102 may include one or more blocks, which may be referred to as prediction units (“PUs”). FIG. 3A shows an example of a CU partition of PUs. The PUs may be used to perform spatial prediction or temporal prediction. A CU can be either spatially or temporally predictively coded. If a CU is coded in intra mode, each PU of the CU can have its own spatial prediction direction. If a CU is coded in inter mode, each PU of the CU can have its own motion vectors and associated reference pictures.

Unlike prior standards where only one transform of 8×8 or 4×4 is applied to a macroblock, a set of block transforms of different sizes may be applied to a CU 102. For example, the CU partition of PUs 202 shown in FIG. 3A may be associated with a set of transform units (“TUs”) 204 shown in FIG. 3B. In FIG. 3B, PU 202-1 is partitioned into four TUs 204-5 through 204-8. Also, TUs 204-2, 204-3, and 204-4 are the same size as corresponding PUs 202-2 through 202-4. Each TU 204 can include one or more transform coefficients in most cases, but may include none (e.g., all zeros). Transform coefficients of the TU 204 can be quantized into one of a finite number of possible values. After the transform coefficients have been quantized, the quantized transform coefficients can be entropy coded to obtain the final compressed bits that can be sent to a decoder.

Three options for the transform process exist in a single layer coding process of discrete cosine transform (“DCT”), discrete sine transform (“DST”), and no transform (e.g., transform skip). However, there are restrictions on which transform option can be used based on the TU size. For example, for any TU size, only two of these options are available.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 shows an input picture partitioned into square blocks referred to as CTUs;

FIG. 2 shows an example of a CTU partition of CUs;

FIG. 3A shows an example of a CU partition of PUs;

FIG. 3B shows a set of TUs;

FIG. 4 depicts an example of a system for encoding and decoding video content according to one embodiment;

FIG. 5 depicts a more detailed example of an adaptive transform manager in an encoder or a decoder according to one embodiment;

FIG. 6 depicts a simplified flowchart of a method for determining whether adaptive transform is available according to one embodiment;

FIGS. 7A through 7E show examples of PU sizes and associated TU sizes where adaptive transform is available according to one embodiment;

FIG. 8 depicts a simplified flowchart of a method for encoding video according to one embodiment;

FIG. 9 depicts a simplified flowchart of a method for decoding video according to one embodiment;

FIG. 10A depicts an example of encoder according to one embodiment; and

FIG. 10B depicts an example of decoder according to one embodiment.

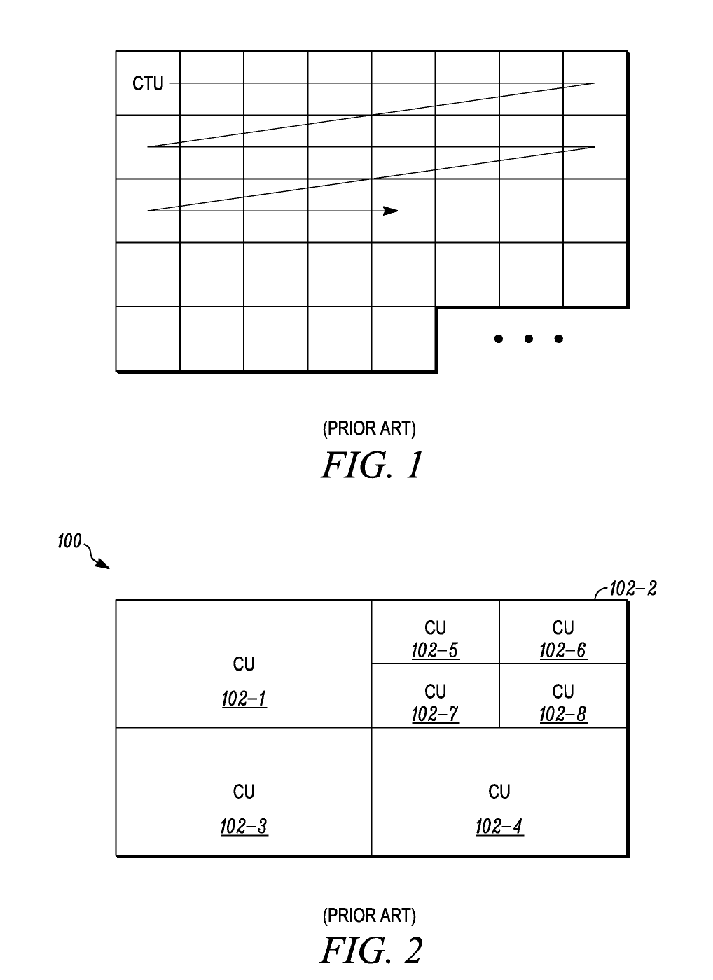

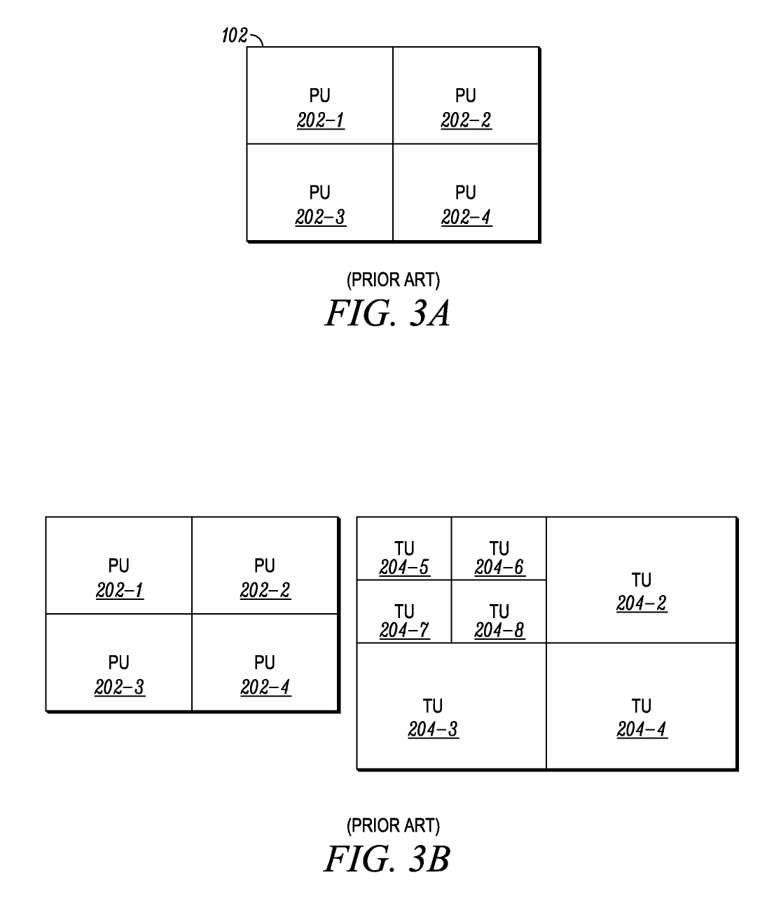

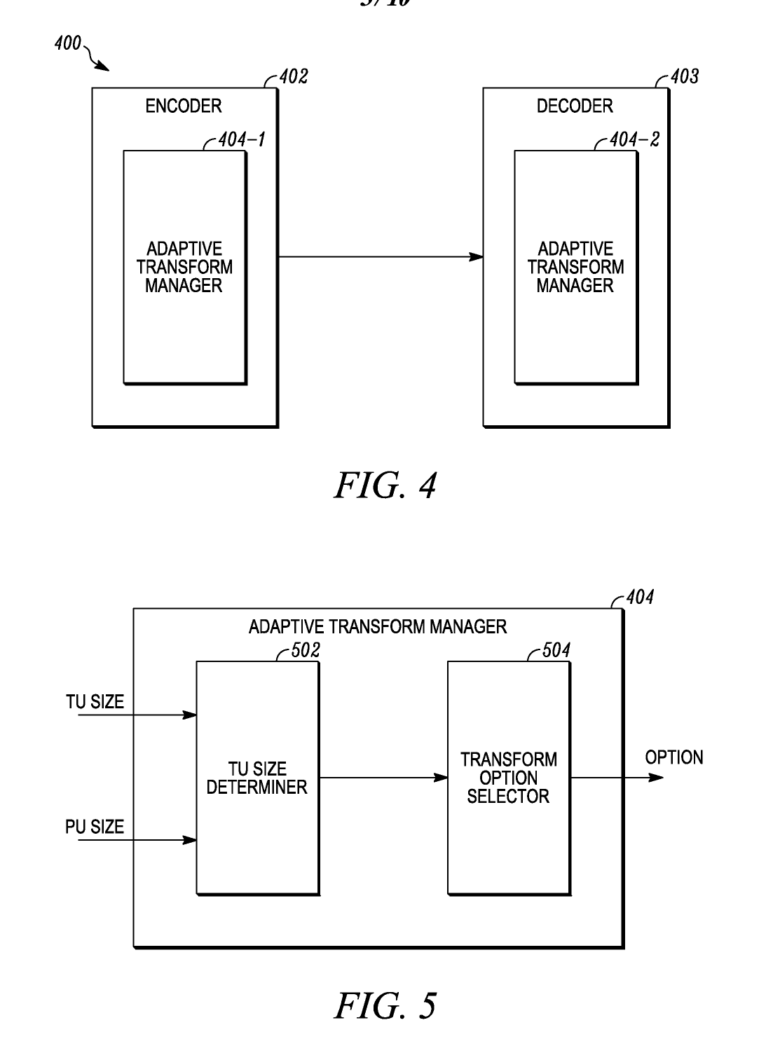

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

In one embodiment, a method determines a first size of a first unit of video used for a prediction process in an enhancement layer (“EL”). The EL is useable to enhance a base layer (“BL”). The method then determines a second size of a second unit of video used for a transform process in the EL and determines whether adaptive transform is to be used in the transform process based on the first size of the first unit and the second size of the second unit where the adaptive transform provides at least three transform options. When adaptive transform is used, a transform option is selected from the at least three transform options for the transform process.

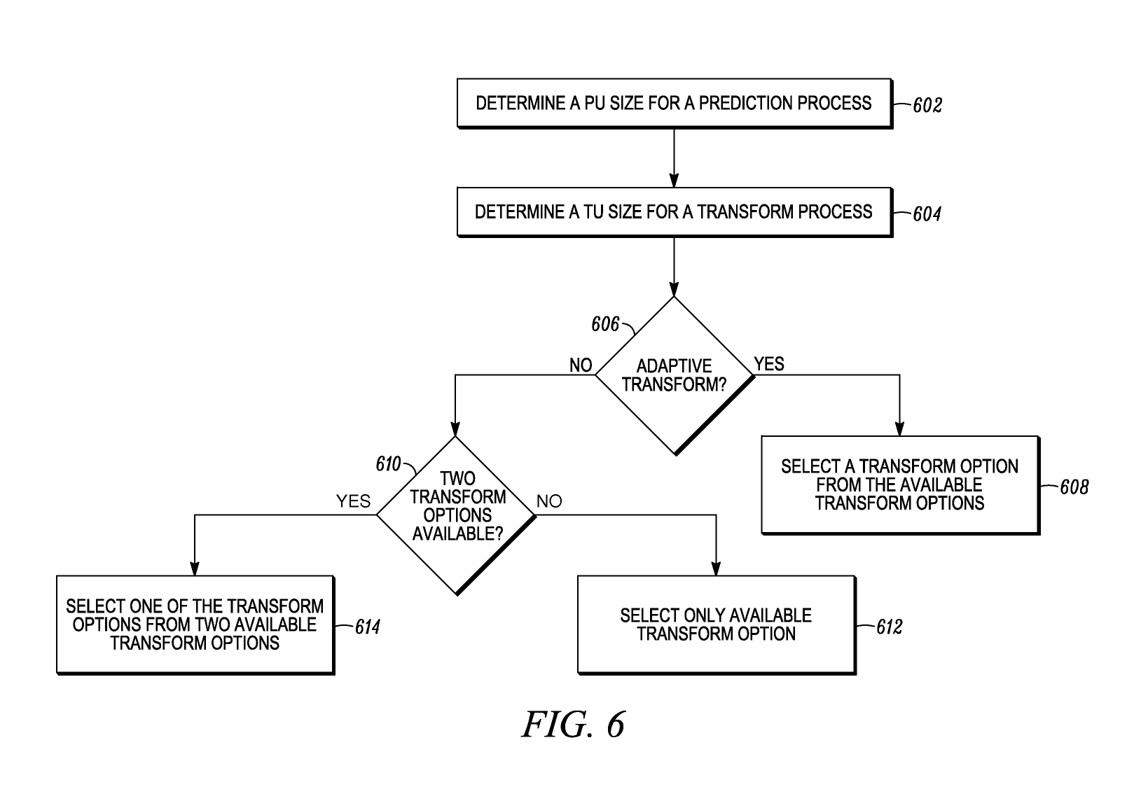

FIG. 4 depicts an example of a system 400 for encoding and decoding video content according to one embodiment. Encoder 402 and decoder 403 may encode and decode a bitstream using HEVC, however, other video-compression standards may also be appreciated.

Scalable video coding supports decoders with different capabilities. An encoder generates multiple bitstreams for an input video. This is in contrast to single layer coding, which only uses one encoded bitstream for a video. One of the output bitstreams, referred to as the base layer, can be decoded by itself, and this bitstream provides the lowest scalability level of the video output. To achieve a higher level of video output, the decoder can process the BL bitstream together with other output bitstreams, referred to as enhancement layers. The EL may be added to the BL to generate higher scalability levels. One example is spatial scalability, where the BL represents the lowest resolution video, and the decoder can generate higher resolution video using the BL bitstream together with additional EL bitstreams. Thus, using additional EL bitstreams produce a better quality video output.

Encoder 402 may use scalable video coding to send multiple bitstreams to different decoders 403. Decoders 403 can then determine which bitstreams to process based on their own capabilities. For example, decoders can pick which quality is desired and process the corresponding bitstreams. For example, each decoder 403 may process the BL and then can decide how many EL bitstreams to combine with the BL for varying levels of quality.

Encoder 402 encodes the BL by down sampling the input video and coding the down-sampled version. To encode the BL, encoder 402 encodes the bitstream with all the information that decoder 403 needs to decode the bitstream. An EL, however, cannot be decoded on its own. To encode an EL, encoder 402 up samples the BL and then subtracts the up-sampled version from the BL. The EL that is coded is smaller than the BL. Encoder 402 may encode any number of ELs.

Encoder 402 and decoder 403 may perform a transform process while encoding/decoding the BL and the ELs. The transform process de-correlates the pixels within a block (e.g., a TU) and compacts the block energy into low-order coefficients in the transform block. A prediction unit for a coding unit undergoes the transform operation, which results in a residual prediction unit in the transform domain.

An adaptive transform manager 404-1 in encoder 402 and an adaptive transform manager 404-2 in decoder 403 select a transform option for scalable video coding. In one embodiment, adaptive transform manager 404 may choose from three transform options of DCT, DST, and no transform (e.g., transform skip).

The transform option of DCT performs best when the TU includes content that is smooth. The transform option of DST generally improves coding performance when the TU's content is not smooth. Further, the transform option of transform skip generally improves coding performance of a TU when content of the unit is sparse. When coding a single layer, and not using scalable video coding, encoder 402 and decoder 403 can use DCT for any TU size. Also, encoder 402 and decoder 403 can only use DST for the 4×4 intra luma TU. The transform skip option is only available for the 4×4 TU, and encoder 402 transmits a flag in the encoded bitstream to signal whether transform skip is used or not. Accordingly, as discussed in the background, at any given TU size, there are only two options available among the three transform options when coding a single layer. For example, the options are either DCT or DST and transform skip.

In scalable video coding, encoder 402 and decoder 403 may use cross-layer prediction in encoding the EL. Cross-layer prediction computes a TU residual by subtracting a predictor, such as up-sampled reconstructed BL video, from the input EL video. When cross-layer prediction is used, a TU generally contains more high-frequency information and becomes sparse. More high-frequency information means the TU's content may not be smooth. Moreover, the TU size is usually larger, and thus encoder 402 and decoder 403 would conventionally use DCT more often because DCT is allowed for TUs larger than 4×4 (DST and transform skip are conventionally only available for 4×4 TUs).

To take advantage of the characteristics of scalable video coding, particular embodiments use adaptive transform, which allows the use of three transform options for TUs, such as for TUs larger than 4×4. Adaptive transform could be used for 4×4 TUs though. Allowing all three transform options for certain TUs may improve coding performance. For example, because the TU in an EL in scalable video coding may include more high-frequency information and become sparse, the DST and the transform-skip options may be better suited for coding the EL. This is because DST may be more efficient with high-frequency information, or no transform may be needed if a small number of transform coefficients exist. Additionally, conventionally, to use either DST or transform skip, the TU size had to be small, (e.g., 4×4), which incurs higher overhead bits. Particular embodiments do not limit the use of DST or transform skip for only the 4×4 TU, which increases the coding efficiency.

When allowing more than two transform options for transform unit sizes, particular embodiment need to coordinate which option to use between encoder 402 and decoder 403. Particular embodiments provide different methods to coordinate the coding between encoder 402 and decoder 403. For example, encoder 402 may signal to decoder 403 which transform option encoder 402 selected. Also, encoder 402 and decoder 403 may implicitly select the transform option based on pre-defined rules.

In one embodiment, encoder 402 signals the transform option selected for each TU regardless of TU size. For example, adaptive transform manager 404-1 in encoder 402 may determine the transform option for each TU that encoder 402 is coding in the EL. Encoder 402 would then encode the selected transform option in the encoded bitstream for the EL for all TUs. In decoder 403, adaptive transform manager 404-2 would read the transform option selected by encoder 402 from the encoded bitstream and select the same transform option. Decoder 403 would then decode the encoded bitstream using the same transform option selected for each TU in encoder 402.

In another embodiment, adaptive transform (e.g., at least three transform options) is allowed at certain TU sizes, and less than three options (e.g., only one option or only two options) are allowed at other TU sizes. For example, DCT is used for a first portion of TU sizes, and adaptive transform is used for a second portion of TU sizes. Also, in one embodiment, DST is used only for the intra luma 4×4 TU. In the second portion of TU sizes, in this embodiment, all three transform options are available. Also, only when the second portion of TU sizes is used does encoder 402 need to signal which transform option was used. Additionally, the transform-skip option may be only available for an inter-prediction 4×4 TU and an intra-prediction 4×4 TU. In this case, encoder 402 may need to signal what option is used for the 4×4 TU because encoder 402 and decoder 403 have two options available for that size TU.

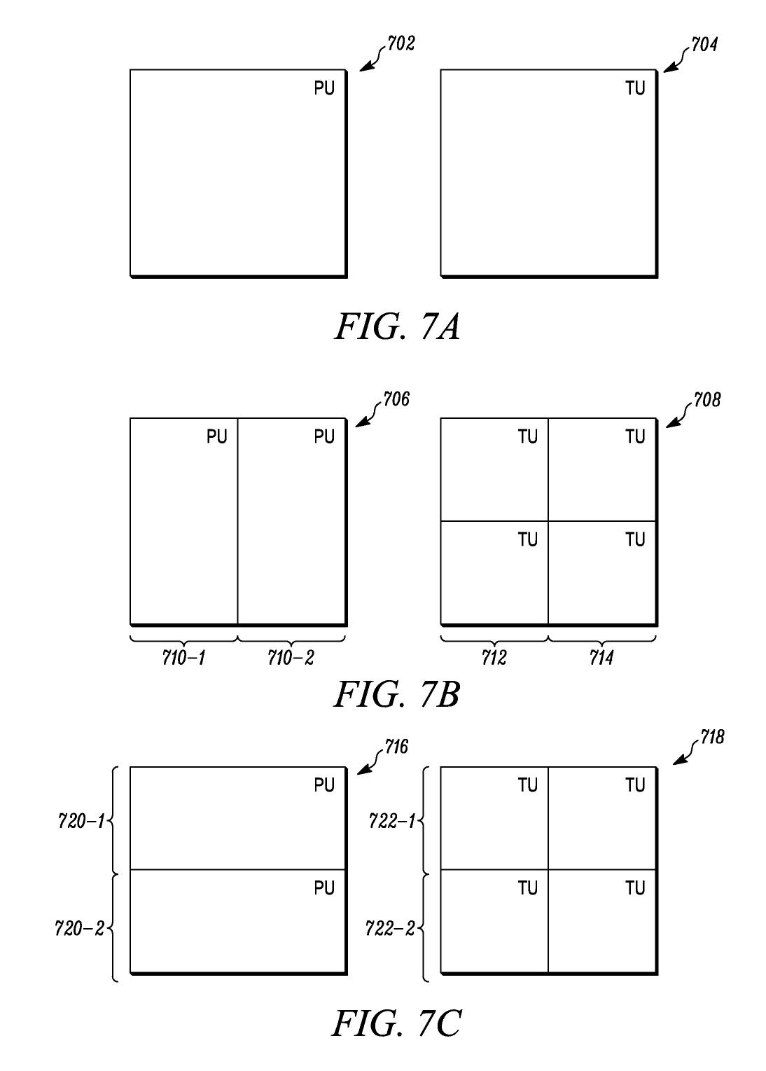

FIG. 5 depicts a more detailed example of an adaptive transform manager 404 in encoder 402 or decoder 403 according to one embodiment. A TU size determiner 502 determines the size of a TU being encoded or decoded. Depending on the size of the TU, TU size determiner 502 may send a signal to a transform-option selector 504 to use adaptive transform or not. As is described in more detail below, TU size determiner 502 may determine if adaptive transform is available based on the PU size and the TU size. For example, for a first portion of TU sizes, encoder 402 and decoder 403 use adaptive transform. However, for a second portion of TU sizes, encoder 402 and decoder 403 do not use adaptive transform.

When adaptive transform is being used, transform-option selector 504 selects between one of the transform options including DCT, DST, and transform skip. Transform-option selector 504 may use characteristics of the video to determine which transform option to use.

When transform-option selector 504 makes the selection, transform-option selector 504 outputs the selection, which encoder 402 or decoder 403 uses to perform the transform process.

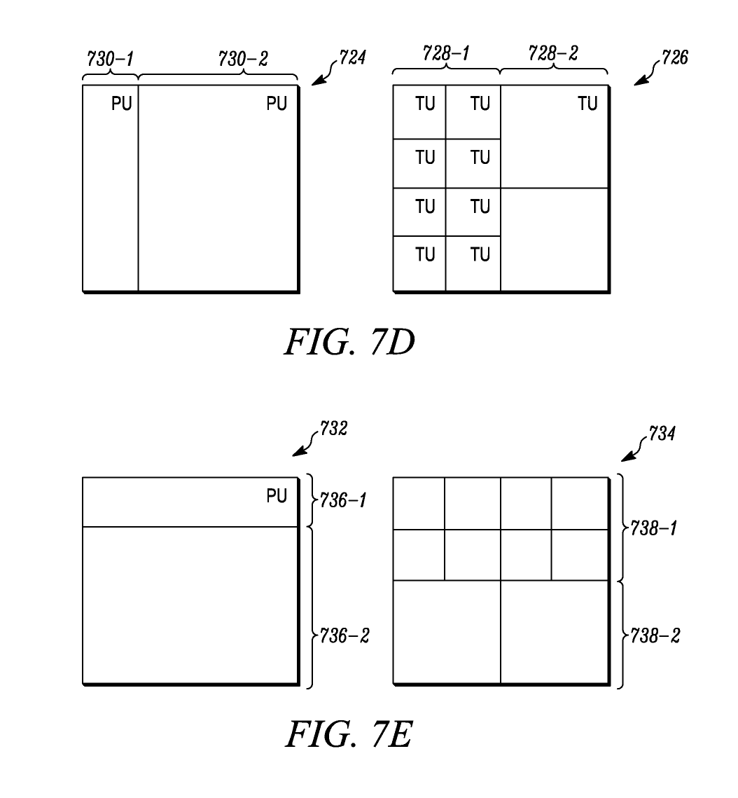

FIG. 6 depicts a simplified flowchart of a method for determining whether adaptive transform is available according to one embodiment. Both encoder 402 and decoder 403 can perform the method. In one embodiment, both encoder 402 and decoder 403 can implicitly determine the transform option to use. However, in other embodiments, the encoder 402 may signal which of the transform options encoder 402 selected, and decoder 403 uses that transform option. At 602, adaptive transform manager 404 determines a PU size for a prediction process. Different PU sizes may be available, such as 2 N×2 N, N×2 N, 2 N×N, 0.5 N×2 N, and 2 N×0.05 N. At 604, adaptive transform manager 404 also determines a TU size for a transform process. The TU sizes that may be available include 2 N×2 N and N×N.

Based on pre-defined rules, adaptive transform manager 404 may determine whether or not adaptive transform is allowed based on the TU size and the PU size. Different examples of when adaptive transform is allowed based on the PU size and the TU size are described below. For example, adaptive transform may be only allowed for the largest TU that fits within an associated PU. Accordingly, at 606, adaptive transform manager 404 determines whether adaptive transform is allowed for this TU. If adaptive transform is allowed, at 608, adaptive transform manager 404 selects a transform option from among three transform options. Adaptive transform manager 404 may select the transform option based on characteristics of the video. On the encoder side, encoder 402 may signal the selected transform option to decoder 403.

If adaptive transform is not used, then at 610, adaptive transform manager 404 determines if two transform options are available. For example, DCT may be the only transform option available for intra 4×4 TU. If only one transform option is available, at 612, adaptive transform manager 404 selects the only available transform option. At 614, if two transform options are available, adaptive transform manager 404 selects one of the two transform options based on characteristics of the video. Encoder 402 may not signal the selected transform option if encoder 402 and decoder 403 do not use adaptive transform. In other cases, encoder 402 may select from two transform options and signal which transform option encoder 402 selected to decoder 403. Also, if only one transform option is available, encoder 402 may or may not signal the selection.

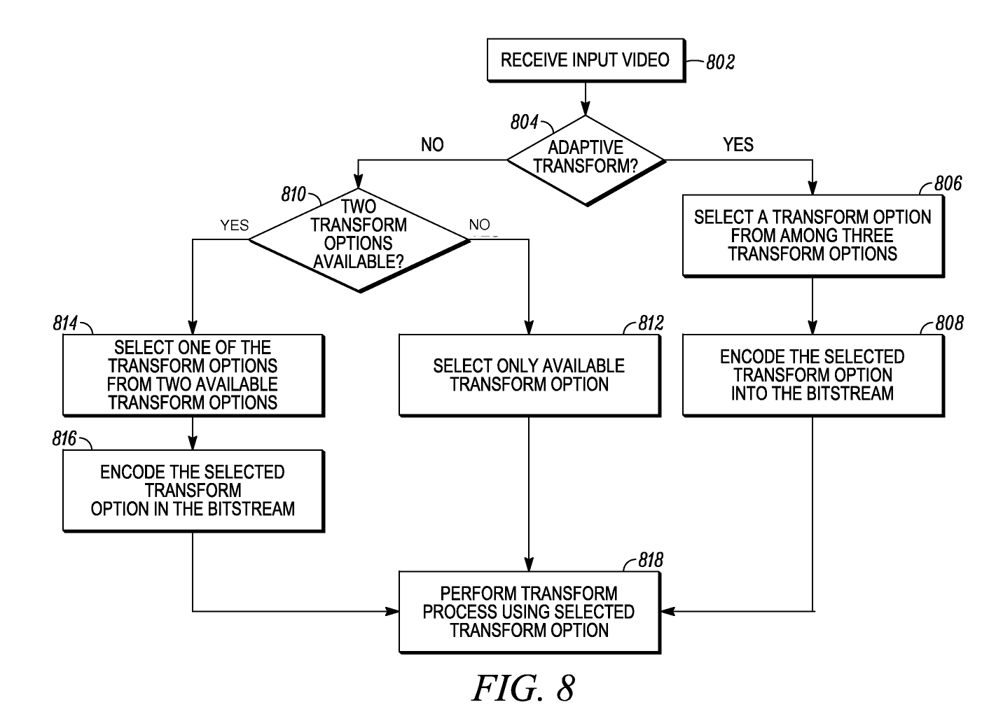

As discussed above, encoder 402 and decoder 403 may use different methods to determine whether adaptive transform can be used. The following describes a method where adaptive transform is available for the largest TU that fits within an associated PU. FIGS. 7A through 7E show examples of PU sizes and associated TU sizes where adaptive transform is available according to one embodiment. FIG. 7A shows a 2 N×2 N PU at 702 and a 2 N×2 N TU at 704. In this case, the 2 N×2 N TU is the largest TU that fits within the 2 N×2 N PU. Adaptive transform manager 404 determines that the 2 N×2 N TU has adaptive transform available. For other TU sizes, adaptive transform is not available.

FIG. 7B shows an N×2 N PU at 706 and an N×N at 708. The N×N TU is the largest TU size that can fit within an N×2 N PU. For example, PUs are shown at 710-1 and 710-2, and the largest size TU that can fit within the PUs at 710-1 and 710-2 is an N×N TU. That is, at 712, the 4×4 TU size fits within the PU at 710-1, and at 714, the 4×4 TU size fits within the PU at 710-2. This is the largest TU size that can fit within the N×2 N PU. For other TU sizes, adaptive transform is not available.

FIG. 7C shows a 2 N×N PU at 716 and an N×N TU at 718. In this case, the same size N×N TU is the largest TU size that can fit within the 2 N×N PU. The same concept as described with respect to FIG. 7B applies for the PUs shown at 720-1 and 720-2. The TUs shown at 722-1 and 722-2 are the largest TU sizes that fit within the PUs shown at 720-1 and 720-2, respectively. For other TU sizes, adaptive transform is not available.

FIG. 7D shows a 0.5 N×2 N PU at 724, a 0.5 N×0.5 N TU at 726, and an N×N TU at 728. Due to the different size PUs shown at 724, different size TUs are used. For example, the largest TU size that fits within the PU shown at 730-1 is the 0.5 N×0.5 N TU shown at 728-1. However, the largest TU size that fits within the PU shown at 730-2 is the N×N TU shown at 728-2. The N×N TU does not cover the entire PU, and encoder 402 and decoder 403 do not use adaptive transform for the PU at 730-2. For other TU sizes, adaptive transform is not available.

FIG. 7E shows a 2 N×0.5 N PU at 732, a 0.5 N×0.5 N TU at 734, and an N×N TU at 736. FIG. 7E is similar to FIG. 7D where the 0.5 N×05 N TU at 738-1 can be used for a PU shown at 736-1. For the PU shown at 736-2, a 4×4 TU size at 738-2 does not fully fit within the PU shown at 736-2, and encoder 402 and decoder 403 do not use adaptive transform. For other TU sizes, adaptive transform is not available.

In summary, particular embodiments allow adaptive transform for a TU size of N×N when the PU size is not 2 N×2 N. Also, it is possible that a TU can cover more than one PU.

In one embodiment, to provide a higher adaptivity of transform options for a TU, each dimension of the transform can use a different type of transform option. For example, the horizontal transform may use DCT, and the vertical transform may use transform skip.

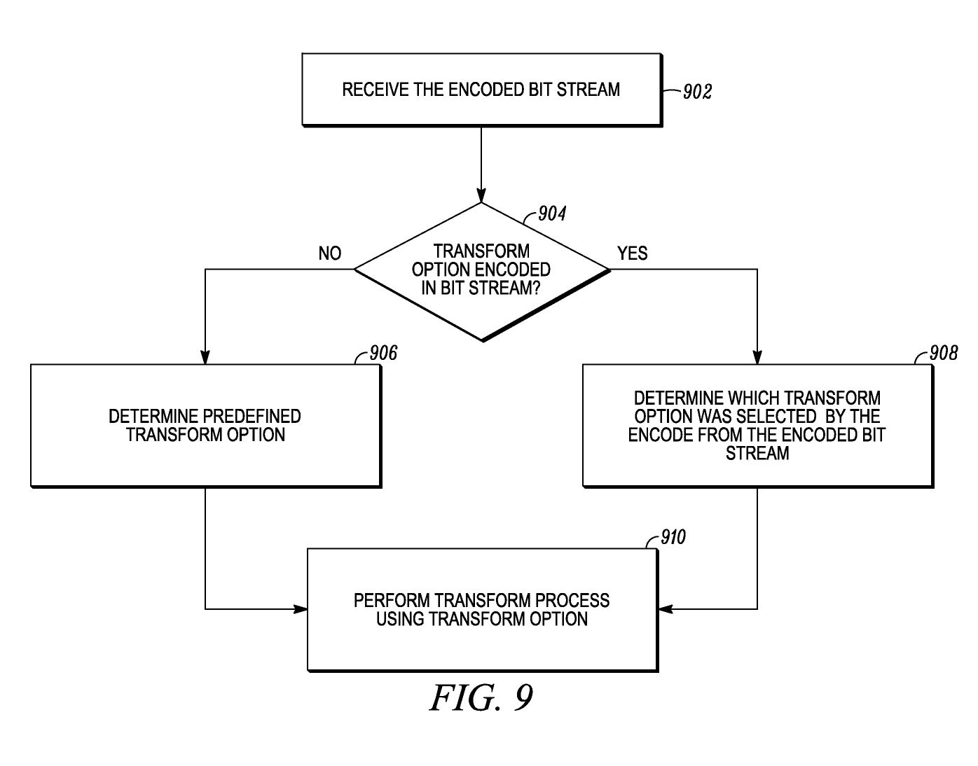

FIG. 8 depicts a simplified flowchart of a method for encoding video according to one embodiment. At 802, encoder 402 receives input video. At 804, encoder 402 determines if adaptive transform can be used. Encoder 402 may use the requirements described above to determine if adaptive transform should be used.

At 806, encoder 402 selects a transform option from among three transform options if adaptive transform is allowed. At 808, encoder 402 then encodes the selected transform option in the encoded bitstream. However, at 810, if adaptive transform is not used, then encoder 402 determines if two transform options are available. If only one transform option is available, at 812, encoder 402 selects the only available transform option. At 814, if two transform options are available, encoder 402 selects one of the two transform options based on characteristics of the video. At 816, encoder 402 then encodes the selected transform option in the encoded bitstream. Also, if only one transform option is available, encoder 402 may or may not signal the selection. At 818, encoder 402 performs the transform process using the transform option that was selected.

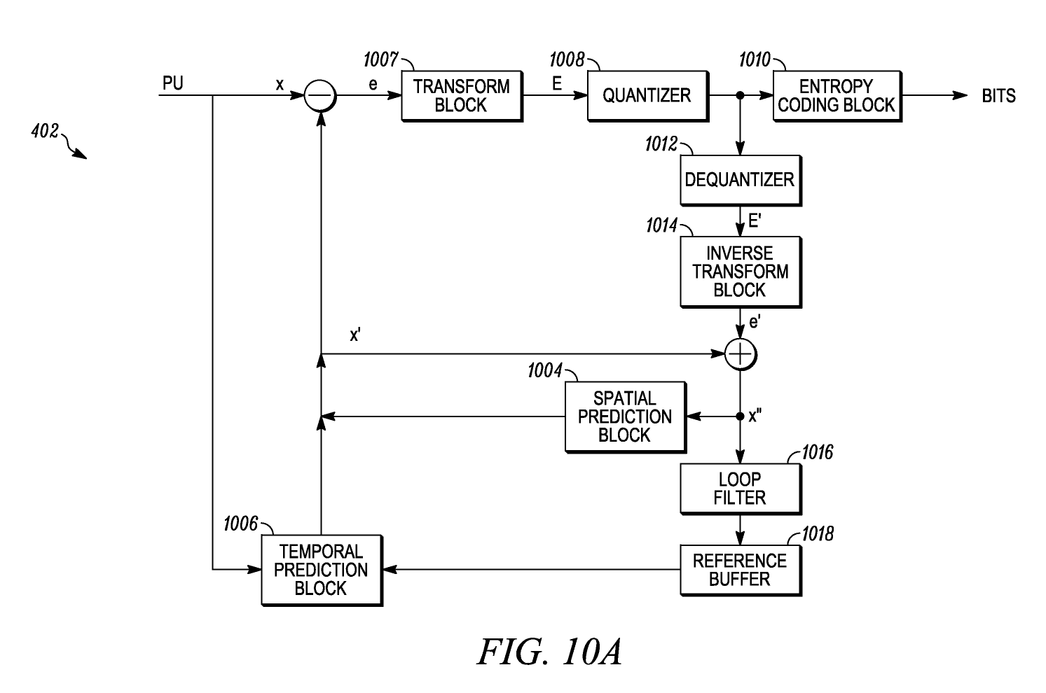

FIG. 9 depicts a simplified flowchart of a method for decoding video according to one embodiment. At 902, decoder 403 receives the encoded bitstream. At 904, decoder 403 determines if a transform option has been encoded in the bitstream. If not, at 906, decoder 403 determines a pre-defined transform option. For example, decoder 403 may implicitly determine the transform option.

If adaptive transform is allowed and the selected option is included in the encoded bitstream, at 908, decoder 403 determines which transform option was selected by encoder 402 based on information encoded in the bitstream. At 910, decoder 403 performs the transform process using the transform option determined.

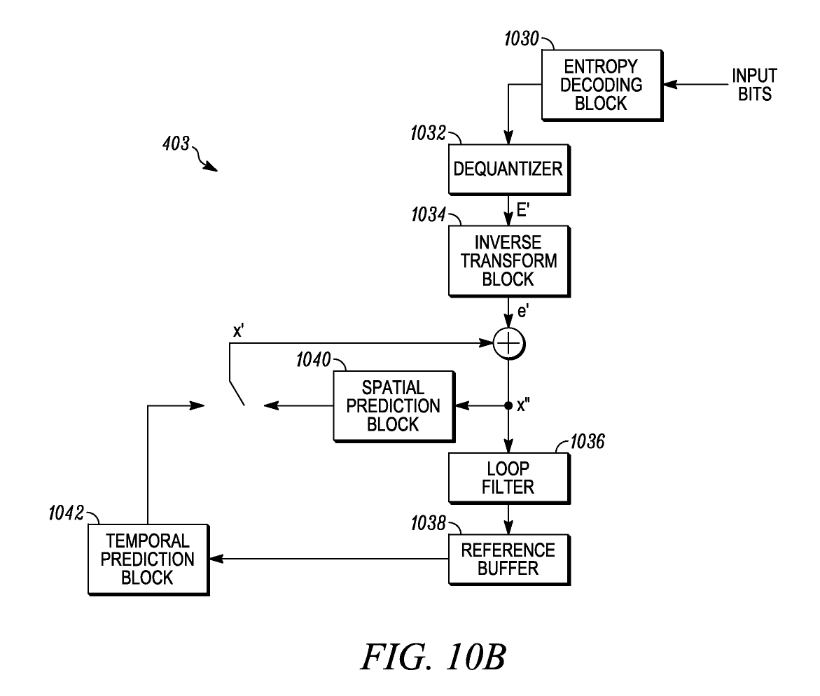

In various embodiments, encoder 402 described can be incorporated or otherwise associated with a transcoder or an encoding apparatus at a headend, and decoder 403 can be incorporated or otherwise associated with a downstream device, such as a mobile device, a set-top box, or a transcoder. FIG. 10A depicts an example of encoder 402 according to one embodiment. A general operation of encoder 402 is now described; however, it will be understood that variations on the encoding process described will be appreciated by a person skilled in the art based on the disclosure and teachings herein.

For a current PU, x, a prediction PU, x′, is obtained through either spatial prediction or temporal prediction. The prediction PU is then subtracted from the current PU, resulting in a residual PU, e. Spatial prediction relates to intra mode pictures. Intra mode coding can use data from the current input image, without referring to other images, to code an I picture. A spatial prediction block 1004 may include different spatial prediction directions per PU, such as horizontal, vertical, 45-degree diagonal, 135-degree diagonal, DC (flat averaging), and planar, or any other direction. The spatial prediction direction for the PU can be coded as a syntax element. In some embodiments, brightness information (“Luma”) and color information (“Chroma”) for the PU can be predicted separately. In one embodiment, the number of Luma intra prediction modes for all block size is 35. In alternate embodiments, the number of Luma intra prediction modes for blocks of any size can be 35. An additional mode can be used for the Chroma intra prediction mode. In some embodiments, the Chroma prediction mode can be called “IntraFromLuma.”

Temporal prediction block 1006 performs temporal prediction. Inter mode coding can use data from the current input image and one or more reference images to code “P” pictures or “B” pictures. In some situations or embodiments, inter mode coding can result in higher compression than intra mode coding. In inter mode PUs can be temporally predictive coded, such that each PU of the CU can have one or more motion vectors and one or more associated reference images. Temporal prediction can be performed through a motion estimation operation that searches for a best match prediction for the PU over the associated reference images. The best match prediction can be described by the motion vectors and associated reference images. P pictures use data from the current input image and one or more previous reference images. B pictures use data from the current input image and both previous and subsequent reference images and can have up to two motion vectors. The motion vectors and reference pictures can be coded in the HEVC bitstream. In some embodiments, the motion vectors can be syntax elements motion vector (“MV”), and the reference pictures can be syntax elements reference picture index (“refIdx”). In some embodiments, inter mode can allow both spatial and temporal predictive coding. The best match prediction is described by the MV and associated refIdx. The MV and associated refIdx are included in the coded bitstream.

Transform block 1007 performs a transform operation with the residual PU, e. A set of block transforms of different sizes can be performed on a CU, such that some PUs can be divided into smaller TUs and other PUs can have TUs the same size as the PU. Division of CUs and PUs into TUs can be shown by a quadtree representation. Transform block 1007 outputs the residual PU in a transform domain, E.

A quantizer 1008 then quantizes the transform coefficients of the residual PU, E. Quantizer 1008 converts the transform coefficients into a finite number of possible values. In some embodiments, this is a lossy operation in which data lost by quantization may not be recoverable. After the transform coefficients have been quantized, entropy coding block 1010 entropy encodes the quantized coefficients, which results in final compression bits to be transmitted. Different entropy coding methods may be used, such as context-adaptive variable length coding or context-adaptive binary arithmetic coding.

Also, in a decoding process within encoder 402, a de-quantizer 1012 de-quantizes the quantized transform coefficients of the residual PU. De-quantizer 1012 then outputs the de-quantized transform coefficients of the residual PU, E′. An inverse transform block 1014 receives the de-quantized transform coefficients, which are then inverse transformed resulting in a reconstructed residual PU, e′. The reconstructed PU, e′, is then added to the corresponding prediction, x′, either spatial or temporal, to form the new reconstructed PU, x″. Particular embodiments may be used in determining the prediction, such as collocated picture manager 404 is used in the prediction process to determine the collocated picture to use. A loop filter 1016 performs de-blocking on the reconstructed PU, x″, to reduce blocking artifacts. Additionally, loop filter 1016 may perform a sample adaptive offset process after the completion of the de-blocking filter process for the decoded picture, which compensates for a pixel value offset between reconstructed pixels and original pixels. Also, loop filter 1016 may perform adaptive loop filtering over the reconstructed PU, which minimizes coding distortion between the input and output pictures. Additionally, if the reconstructed pictures are reference pictures, the reference pictures are stored in a reference buffer 1018 for future temporal prediction. Intra mode coded images can be a possible point where decoding can begin without needing additional reconstructed images.

FIG. 10B depicts an example of decoder 403 according to one embodiment. A general operation of decoder 403 is now described; however, it will be understood that variations on the decoding process described will be appreciated by a person skilled in the art based on the disclosure and teachings herein. Decoder 403 receives input bits from encoder 402 for encoded video content.

An entropy decoding block 1030 performs entropy decoding on the input bitstream to generate quantized transform coefficients of a residual PU. A de-quantizer 1032 de-quantizes the quantized transform coefficients of the residual PU. De-quantizer 1032 then outputs the de-quantized transform coefficients of the residual PU, E′. An inverse transform block 1034 receives the de-quantized transform coefficients, which are then inverse transformed resulting in a reconstructed residual PU, e′.

The reconstructed PU, e′, is then added to the corresponding prediction, x′, either spatial or temporal, to form the new reconstructed PU, x″. A loop filter 1036 performs de-blocking on the reconstructed PU, x″, to reduce blocking artifacts. Additionally, loop filter 1036 may perform a sample adaptive offset process after the completion of the de-blocking filter process for the decoded picture, which compensates for a pixel value offset between reconstructed pixels and original pixels. Also, loop filter 1036 may perform adaptive loop filtering over the reconstructed PU, which minimizes coding distortion between the input and output pictures. Additionally, if the reconstructed pictures are reference pictures, the reference pictures are stored in a reference buffer 1038 for future temporal prediction.

The prediction PU, x′, is obtained through either spatial prediction or temporal prediction. A spatial prediction block 1040 may receive decoded spatial prediction directions per PU, such as horizontal, vertical, 45-degree diagonal, 135-degree diagonal, DC (flat averaging), and planar. The spatial prediction directions are used to determine the prediction PU, x′.

A temporal prediction block 1042 performs temporal prediction through a motion-estimation operation. Particular embodiments may be used in determining the prediction, such as collocated picture manager is used in the prediction process to determine the collocated picture to use. A decoded motion vector is used to determine the prediction PU, x′. Interpolation may be used in the motion estimation operation.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method comprising:
determining, by a computing device, a first size of a first unit of video used for a prediction process in an enhancement layer, wherein the enhancement layer is useable to enhance a base layer;
determining, by the computing device, a second size of a second unit of video used for a transform process in the enhancement layer;
determining, by the computing device, whether adaptive transform is to be used in the transform process based on the first size of the first unit and the second size of the second unit, wherein the adaptive transform provides at least three transform options; and
when adaptive transform is used, selecting, by the computing device, a transform option from the at least three transform options for the transform process.

2. The method of claim 1 further comprising signaling the selected transform option from an encoder to a decoder when adaptive transform is used.

3. The method of claim 1 further comprising signaling the selected transform option from an encoder to a decoder for all sizes of the second unit of video.

4. The method of claim 1 further comprising when adaptive transform is not used, selecting from only two transform options that are available.

5. The method of claim 4 wherein the selected one of the only two transform options is signaled from an encoder to a decoder.

6. The method of claim 1 further comprising when adaptive transform is not used, determining a single transform option that is available.

7. The method of claim 6 wherein the single transform option is not signaled from an encoder to a decoder.

8. The method of claim 1 wherein determining whether adaptive transform is to be used in the transform process comprises allowing the adaptive transform for a largest size of the second size of the second unit of video that fits within the first size of the first unit of video.

9. The method of claim 1 wherein determining whether adaptive transform is to be used in the transform process comprises:
determining the first size is a 2 N×2 N prediction unit;
determining the second size is a 2 N×2 N transform unit; and
determining adaptive transform is to be used in the transform process when the second size is 2 N×2 N and the first size is 2 N×2 N.

10. The method of claim 1 wherein determining whether adaptive transform is to be used in the transform process comprises:
determining the first size is a N×2 N prediction unit;
determining the second size is a N×N transform unit; and
determining adaptive transform is to be used in the transform process when the second size is N×N and the first size is N×2 N.

11. The method of claim 1 wherein determining whether adaptive transform is to be used in the transform process comprises:
determining the first size is a 2 N×N prediction unit;
determining the second size is a N×N transform unit; and
determining adaptive transform is to be used in the transform process when the second size is 2 N×N and the first size is N×N.

12. The method of claim 1 wherein determining whether adaptive transform is to be used in the transform process comprises:
determining the first size is a 0.5 N×2 N prediction unit;
determining the second size is a 0.5 N×0.5 N transform unit; and
determining adaptive transform is to be used in the transform process for a 0.5 N×0.5 N portion of the 0.5 N×2 N prediction unit when the second size is 0.5 N×0.5 N.

13. The method of claim 1 wherein determining whether adaptive transform is to be used in the transform process comprises:
determining the first size is a 2 N×0.5 N prediction unit;
determining the second size is a 0.5 N×0.5 N transform unit; and
determining adaptive transform is to be used in the transform process for a 0.5 N×0.5 N portion of the 2 N×0.5 N prediction unit when the second size is 0.5 N×0.5 N.

14. The method of claim 1 wherein adaptive transform is to be used in the transform process for all sizes of the first size of the first unit of video and the second size of the second unit of video.

15. The method of claim 1 wherein adaptive transform is to be used in the transform process for a first portion of sizes for the second unit of video and not to be used for a second portion of sizes for the second unit of video.

16. The method of claim 1 wherein the first unit of video is a prediction unit and the second unit of video is a transform unit.

17. A decoder comprising:
one or more computer processors; and
a non-transitory computer-readable storage medium comprising instructions that, when executed, control the one or more computer processors to be configured for:
receiving an encoded bitstream;
determining if information is included in the encoded bitstream for a selected transform option, wherein an encoder selected the transform option based on a first size of a first unit of video used for a prediction process in an enhancement layer that is useable to enhance a base layer and a second size of a second unit of video used for a transform process in the enhancement layer, wherein the transform option is selected from at least three transform options; and
when information is included in the encoded bitstream for the selected transform option, using the selected transform option from the at least three transform options for the transform process.

18. The decoder of claim 17 wherein when the information is not included in the encoded bitstream for the selected transform option, the decoder is configured for:
determining the first size of the first unit of video;
determining the second size of the second unit of video;
determining whether adaptive transform is to be used in the transform process based on the first size of the first unit and the second size of the second unit, wherein the adaptive transform provides the at least three transform options; and
when adaptive transform is used, selecting a transform option from the at least three transform options for the transform process.

19. An encoder comprising:
one or more computer processors; and
a non-transitory computer-readable storage medium comprising instructions that, when executed, control the one or more computer processors to be configured for:
determining a first size of a first unit of video used for a prediction process in an enhancement layer, wherein the enhancement layer is useable to enhance a base layer;
determining a second size of a second unit of video used for a transform process in the enhancement layer;
determining whether adaptive transform is to be used in the transform process based on the first size of the first unit and the second size of the second unit, wherein the adaptive transform provides at least three transform options; and
when adaptive transform is used, selecting a transform option from the at least three transform options for the transform process.

20. The encoder of claim 19 further configured for signaling the selected transform option from an encoder to a decoder when adaptive transform is used.
